(19) United States
(12) Patent Application Publication
(10) Pub. No.: US 2021/0299569 A1
(43) Pub. Date: Sep. 30, 2021

(54) SYSTEM, DEVICES AND/OR PROCESSES FOR INCENTIVISED SHARING OF COMPUTATION RESOURCES

(71) Applicant: ARM IP Limited, Cambridge (GB)

(72) Inventors: Damon Jay Civin, San Jose, CA (US); John Ronald Fry, Campbell, CA (US)

(21) Appl. No.: 17/203,545

(22) Filed: Mar. 16, 2021

Related U.S. Application Data
(60) Provisional application No. 63/003,102, filed on Mar. 31, 2020.

(51) Int. Cl. A63F 13/67; G06N 20/00; G06N 3/08

(52) U.S. Cl. CPC A63F 13/67; G06N 3/08; G06N 20/00

(57) ABSTRACT

Briefly, example methods, apparatuses, and/or articles of manufacture are disclosed that may be implemented, in whole or in part, using one or more processing devices to facilitate and/or support participation in computing activities by multiple parties.

This application claims the benefit of priority to U.S. Provisional Patent Appl. Ser. No. 63/003,102 titled “SYSTEM, DEVICES AND/OR PROCESSES FOR INCENTIVISED SHARING OF COMPUTATION RESOURCES,” filed on Mar. 31, 2020, assigned to the assignee of claimed subject matter, and incorporated herein by reference in its entirety.

### BACKGROUND

### 1. Field

The present disclosure relates generally to implementation of system to incentive sharing of computing resources.

### 2. Information

There are strong economic, practical and/or technical incentives to defer and/or delegate aspects of computations among multiple parties. For example, such delegation of computation may include delegation of computation into a “cloud”—with a cloud host acting as a delegate, providing computational services. Other examples may include, for example, ancestry testing services such as 23andMe, which may provide computation services and/or perform computations on genetic data extracted from customer-provided cheek swabs, for example. With an ever-increasing number of software- and/or computation-based services on offer, a number of delegated computations is sure to increase as well.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram of an example system according to embodiments;

FIG. 2 is a flow diagram of a process for collaborative computation according to an embodiment;

FIG. 3 is a flow diagram of a process which may be executed in the course of an iteration of a machine learning task according to an embodiment; and

FIG. 4 is a schematic diagram illustrating an implementation of an example computing environment associated with processes to facilitate multi-party and/or delegated computing according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

Briefly, embodiments described herein are directed to features of a system to incentivize multiple parties to share proprietary parameters and/or secrets with one another by offering a fair reward to parties based, at least in part, on a value of proprietary parameters and/or secrets provided. “Proprietary parameters and/or secrets” as referred to herein means signals and/or states expressing content for which there is value to a party (e.g., a program input provider entity) to limit and/or prevent disclosure. Such content expressed in secret and/or proprietary parameters may include, for example, parameters, values, symbol bits, elements, characters, numbers, numerals, measurements, text, formulas images and/or records. It should be understood, however, that these are merely examples of content which may be expressed by secret and/or proprietary parameters, and claimed subject matter is not limited in this respect. In particular implementations, features of a system to incentivize multiple parties to share proprietary parameters and/or secrets with one another by offering a fair reward to parties may enable, among other things:
1) additional use cases for data science by joining diverse sets of proprietary parameters and/or secrets (e.g., IoT values, measurements and/or parameters like pedestrian count past a billboard to enterprise proprietary parameters and/or secrets like an online advertising campaign);
2) improved machine learning models to be built by rewarding collaboration and disincentivizing hoarding of proprietary parameters and/or secrets; and
3) enablement of smaller or more specialized parties to participate in the information economy rather than be dominated by bigger, powerful parties.

According to an embodiment, a system to incentive sharing of computational inputs may comprise: a mechanism for determining a value of computing inputs and a distribution of gains associated with use of such computing inputs; a mechanism for sharing computing inputs; and a mechanisms for using shared computing inputs for analysis (e.g., at multiple levels of granularity).

In addition to sharing computing inputs, different players have a joint interest in completion of a computing task. For example, a car manufacturer predicting maintenance needs, a bank trying to reduce fraud and/or autonomous vehicle company training a model to drive autonomously may collectively have an interest in completion of a computing task.

In some scenarios, a “player” may have an interest in a computational model that may employ proprietary parameters and/or secrets of competitors as inputs. With current incentives, however, rather than share such proprietary parameters and/or secrets, such a competitor may be more interested in “hoarding” its proprietary parameters and/or secrets and, consequently, build larger stores of proprietary parameters and/or secrets and train a better machine-learning model, for example. Additionally, with collaborative computation in which multiple players contribute proprietary parameters and/or secrets, it may be difficult to quantify a relative value of contributions from different individual players.

Impediments to a computational model that employs collaborative use of proprietary parameters and/or secrets from different parties may also include, for example, a difficulty in sharing proprietary parameters and/or secrets from a legal, privacy & cost perspective, pre-processing of raw proprietary parameters and/or secrets into different forms for use in different tasks.

According to an embodiment, features described herein may be employed to facilitate and/or incentivize collaborative use of proprietary parameters and/or secrets from different parties to complete computational tasks. In one aspect, features described herein may be used to implement a reward system for different parties for contributions of their proprietary parameters and/or secrets to complete computational tasks. In another aspect, features described herein may at least partially overcome challenges for enabling different parties to share proprietary parameters and/or secrets by application of transformations and/or manipulations of the proprietary parameters and/or secrets.

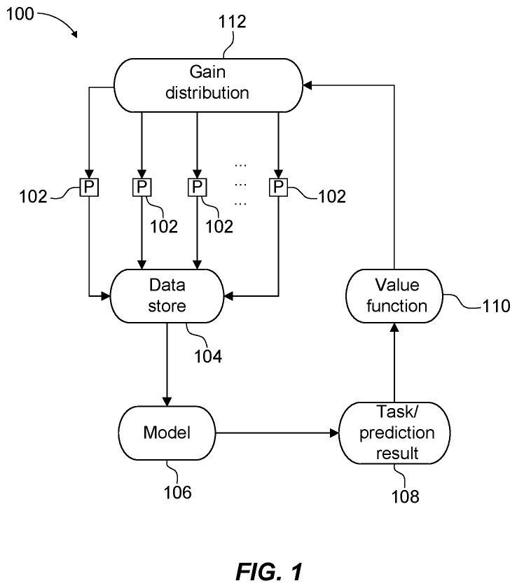

FIG. 1 is a schematic diagram of an example system 100 according to embodiments to implement one or more features to incentivize collaborative computation. Multiple different parties 102 may comprise entities such as, for example, private enterprise entities, individual persons, government agencies, educational institutions, just to provide a few examples. In particular implementations, parties 102 may comprise entities that may derive a benefit from execution of computational tasks and/or predictions executed at model 106. Parties 102 may also comprise entities capable of furnishing proprietary parameters and/or secrets for use in collaborative computation at model 106.

According to an embodiment, data store 104 may comprise physical devices to maintain signals and/or states expressing proprietary parameters and/or secrets provided by parties 102 in non-transitory and tangible memory devices. In one example, implementation, data store 104 may comprise devices physically maintained at a single location which are accessible via messages transmitted over a communication network. In other embodiments, data store 104 may comprise physical assets coupled to provide a distributed storage system.

In an embodiment, model 106 may comprise instructions executable by computing resources (e.g., processors, buses, memory, power source(s), etc.) to process proprietary parameters and/or secrets provided by multiple parties 102 and maintained in data store 104. In an embodiment, execution of instructions may comprise execution of an algorithm and/or machine learning-based model to perform computational tasks and/or predictions to provide a task/prediction result 108 based, at least in part, on proprietary parameters and/or secrets provided by multiple parties 102 and maintained in data store 104.

According to an embodiment, value function 110 may determine a value of task/prediction result 108 based, at least in part, on particular metrics such as, for example, accuracy and/or reliability. In a particular implementation, value function 110 may quantify such a value of task/prediction result 108 according to particular units such as currency (e.g., US dollars, Euros, electronic currency, etc.). Such a quantified value of task/prediction result 108 may provide at least a partial basis of a collective reward to be distributed between and/or among parties 102. Gain distribution 112 may allocate such a collective reward between and/or among parties 102. In a particular implementation, gain distribution 112 may determine a portion of a collective reward to be distributed to a particular player 102 based, at least in part, on a perceived contribution of proprietary parameters and/or secrets to achieve a quantified value of task/prediction result 108.

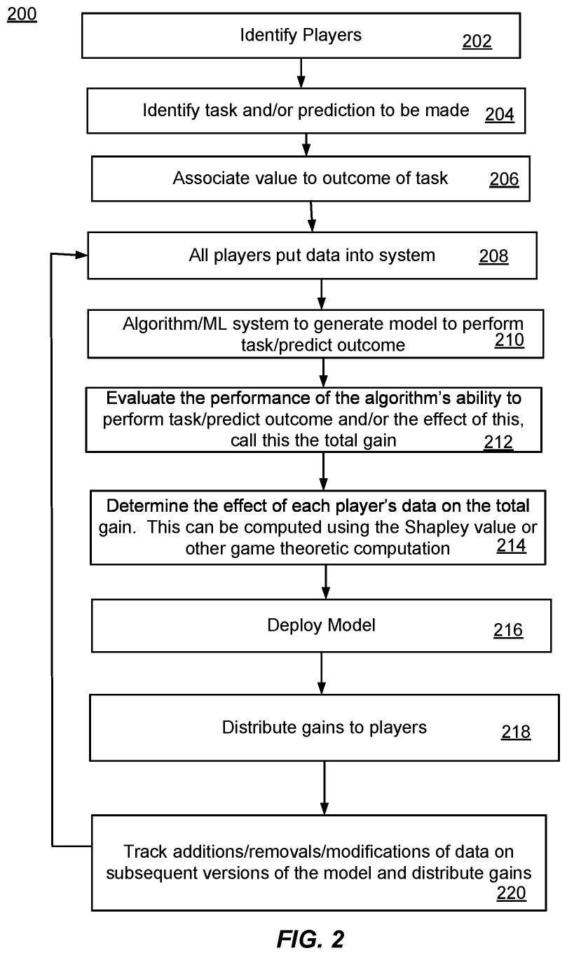

FIG. 2 is a flow diagram of a process for collaborative computation according to an embodiment, such as a process for collaborative computation implemented in system 100. According to an embodiment, block 202 may comprise an identification of players such as players 102. This may comprise, for example, determining identities of players and determining characterizing proprietary parameters and/or secrets that may be provided by players. Block 204 may comprise characterization of a task and/or prediction to be made such as, for example, a characterization of a task/prediction result 108 to be provided by execution of an algorithm to process proprietary parameters and/or secrets maintained at data store 104, for example. Block 206 may comprise determination of metrics be applied to a task and/or prediction for determining and/or quantifying a value of such a task and/or prediction. For example, block 206 may comprise a determination of metrics to be applied by value function 110 for determining and/or quantifying a value of task/prediction result 108.

Blocks 208 through 220 may comprise an iteration of execution of a model to process proprietary parameters and/or secrets provided by multiple parties to provide a task/prediction result, and distribution of a collective reward between and/or among parties providing such proprietary parameters and/or secrets. In an example implementation, block 208 may comprise storage of proprietary parameters and/or secrets obtained from parties 102 in data store 104 as signals and/or states representing such proprietary parameters and/or secrets. Block 210 may comprise execution of a model to perform a task/predict an outcome based, at least in part, on proprietary parameters and/or secrets provided at block 208. For example, block 210 may comprise execution of model 106 to process proprietary parameters and/or secrets provided by multiple players 102 (and maintained in data store 104) to generate a task/prediction result 108. Block 212 may comprise an evaluation of an algorithm's ability to perform a task and/or predict an outcome as determined/computed in block 212. In a particular implementation, block 212 may comprise application of metrics (e.g., determined at block 206) by value function 110 to determine a value in a determination of task/prediction result 108. Block 214 may comprise a determination of an effect of individual contributions of proprietary parameters and/or secrets at block 208 to an overall value determined at block 212. For example, block 214 may comprise a determination by gain distribution 112 of a quantitative value of proprietary parameter and/or secrets provided by individual players 102. Block 216 may comprise execution of a model generated at block 210 to determine a result such as, for example, a task/prediction result 108 determined from execution of model 106. Block 218 may comprise distribution of gains from determination of a computed task/prediction result to players having contributed proprietary parameters and/or secrets such as by gain distribution 112 to players 102. At block 220, additions and/or modifications of stored proprietary parameters and/or secrets may be tracked (such as by tracking additions and/or modifications of proprietary parameters and/or secrets maintained in data store 104) for a subsequent iteration of blocks 208 through 218.

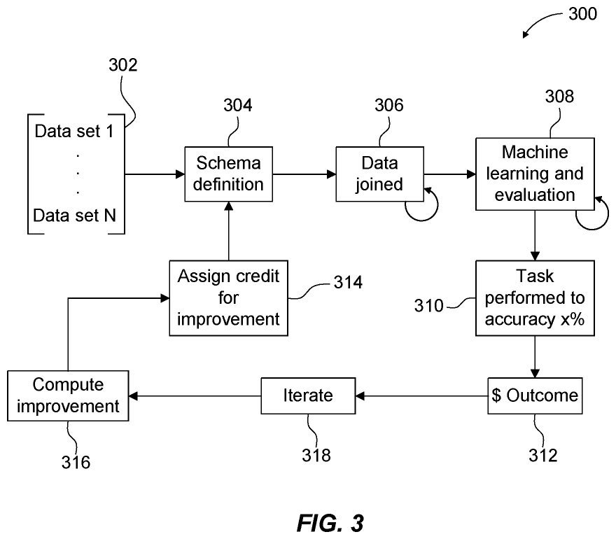

FIG. 3 is a flow diagram of a process 300 which may be executed in the course of an iteration of a machine learning task according to an embodiment. In a particular implementation, one or more aspects of process 300 may be performed in connection with execution of a portion of process 200 such as in an iteration of blocks 208 through 220. In a particular implementation, arrows showing transitions between pairs of blocks 302, 304, 306, 308, 310, 312, 314 and 316 may be automated and/or implemented as a computer language compiler. According to an embodiment, data sets 302 may be matched with specific tasks and expertise to enable faster execution. Accurate machine learning models may enable lower bias and increased confidence in outcomes. Computation engine and/or model may expand a set of tasks, users and datasets that may be included in a machine learning model, and/or may enable more reliable predictions, greater coverage of possible scenarios, fewer “black swan” events (e.g., Nigerian bank crisis).

To address certain challenges to sharing of proprietary parameters and/or secrets between and/or among different parties (e.g., between and/or among parties 102), particular implementations may comprise transformations of proprietary parameters and/or secrets. In one example, a process of model training at block 210 maybe performed locally to transform stored proprietary parameters and/or secrets (e.g., maintained in data store 104). Alternatively, proprietary parameters and/or secrets may be transformed prior to being “shared” in a common storage.

Such transformations of proprietary parameters and/or secrets may be facilitated at least in part by one or more transformation techniques selected by an “owner” of proprietary parameters and/or secrets as follows:

Homomorphic encryption: proprietary parameters and/or secrets may be encrypted before being sent to a central repository (e.g., data store 104) and a model may be trained on encrypted proprietary parameters and/or secrets (with current technology this may limit models to a class of linear models);

Federated learning—proprietary parameters and/or secrets may be maintained at computing resources owned and/or controlled by respective contributing entities (e.g., respective contributing parties 102) where a central model-training agent may be deployed to computing resources owned and/or controlled by respective contributing entities to learn about their proprietary parameters and/or secrets while resulting updates to the model may be sent to a central server;

Masking/Differential privacy—a certain amount of noise may be combined with one or more individual data points so that only aggregate queries can be answered, but none that reveal the individual data point;

Query restriction—a central system (e.g., data store 104) may store proprietary parameters and/or secrets contributed by different entities (e.g., parties 102) in raw form, but only permit aggregated queries (e.g. in the case of proprietary parameters and/or secrets contributed by five banks, only queries that sample from two or more banks may be permitted); and/or

Usage tracking—shared proprietary parameters and/or secrets may be strictly audited in an immutable ledger that tracks accesses, changes and behaviour of entities that query shared proprietary parameters and/or secrets.

In different embodiments, one or more of the aforementioned techniques for challenges to sharing of proprietary parameters and/or secrets between and/or among different parties may be employed. In addition to the aforementioned techniques to better facilitate sharing of proprietary parameters and/or secrets, standard techniques of anonymisation, aggregation, etc. may be applied to comply with regulations like HIPAA and GDPR.

To address certain challenges arising from differences in how different entities contributing proprietary parameters and/or secrets may maintain such contributed proprietary parameters and/or secrets in different formats and/or different granularity, in an embodiment, particular techniques may be applied, for example, as follows:

shared, extensible ontologies/schemas and an incentive structure (e.g., as discussed above) may reward users and/or organisations that improve granularity of contributed proprietary parameters and/or secrets these (for example, if an entity edits a schema for proprietary parameters and/or secrets about buildings that enables one million more rows to be joined correctly, that entity may be rewarded according to a gain-distribution (e.g., according to gain distribution 112)); and/or

compensation to an owner of a model (e.g., model 106) for an output of their model by an owner of a model that consumes it (e.g., if an output of a model is chained together, so the owner of a model may be compensated for the output of their model by the owner of a model that consumes it. For example, suppose a first party Alice owns and/or controls a model that groups different tire brands made by different manufacturers into categories like summer sedan, winter sedan, off-road, etc. and a second party Bob builds a model capable of predicting failure of braking systems based on which particular type of tire that is in use, Alice can be rewarded when Bob is rewarded by users of his model).

In an embodiment, proprietary parameters and/or secrets may become less sensitive and easier to use as a level of aggregation is increased. In particular implementations, one or more of the following techniques may be employed to enable and/or facilitate sharing of proprietary parameters and/or secrets between and/or among parties at multiple granularities:

Peer-to-peer granularity: individuals, corporations, or groups there-of can specify to share proprietary parameters and/or secrets only with each other (this may allow for professional services like data science to be performed privately between two parties within a global data store, for example);

Data granularity: proprietary parameters and/or secrets may be shared at the level of raw data, partially aggregated, and/or data generated by a sub-coalition mentioned above (also, owners can flag that only certain rows, and/or only certain columns may be used for a certain use case); and/or

Model granularity: some users/owners may only want their proprietary parameters and/or secrets, and/or models used for certain purposes, for legal, ethical or other reasons (For example, a user/owner may determine which particular tasks use which portion of contributed proprietary parameters and/or secrets in a ledger. Also, different categories of use may be part of a proprietary parameters and/or secrets ingestion pipeline, part of an ensemble of models to improve performance and lower variance, once-off use only, subscription to a data feed, for a restricted set of end tasks, and/or industry.).

According to an embodiment, parties to a collaborative computing system (e.g., parties 102 in system 100) may comprise entities that own or control particular sets of proprietary parameters and/or secrets, and/or schema. In an embodiment, such a party may have knowledge of and/or visibility into various aspects of such a system and may expect compensation for making contributions (e.g., contributions of proprietary parameters and/or secrets, and/or computing tasks). For example, such a party may receive a list of recommended tasks, models, schemas and advertising options. Such a party may also declare its right and/or permission to publish proprietary parameters and/or secrets, and/or publish descriptions of features of proprietary parameters and/or secrets. Such a party may also set options and/or permissions for use of such proprietary parameters and/or secrets such as, for example, 1) how public, 2) which columns, 3) permitted and/or available level of aggregation, 4) permitted and/or available tasks, 5) permitted resharing, 6) permitted and/or available number of uses, 7) minimum bounty and/or 8) willingness and/or capabilities to perform additional processing of proprietary parameters and/or secrets. Such a party may also establish schema and documentation. Such a party may also specify any attribution of specific proprietary parameters and/or secrets and/or specify any dependencies on other datasets. Such a party may also receive a list of recommended tasks, models, schema, usages and/or advertising options.

An owner of a particular schema may have knowledge of how features/attributes of particular models, tasks and sets of proprietary parameters and/or secrets may be improved by joining and/or cleaning. Such a schema owner may also perform relevant processing associated with a task, and receive compensation and/or reward from an owner of such a task. Such an owner of a particular schema may further define and/or determine publishing criteria.

According to an embodiment, parties to a collaborative computing system (e.g., parties 102 in system 100) may comprise a “task owner” that owns or controls particular a particular task and/or prediction (e.g., task/prediction result 108) to be computed based, at least in part, on shared proprietary parameters and/or secrets. For example, such a task owner may define a particular task such as, for example, a prediction of failure of one or more automobile braking systems. Having knowledge of and/or visibility into various aspects of a collaborative computing system, a task owner may publish a task defined, at least in part, by attributes such as a goal, success criteria, a bounty, identification of functions/processes sought for completion of a task/prediction and/or time scale. Publishing options for a particular task may include, for example, clearance, geography, reputation and/or SPPR specifics. Such a task owner may also publish and/or advertise users sought, particular proprietary parameter and/or secrets sought for completion of a task/prediction, particular schema sought and/or particular models being sought. Such a task owner may have an option to choose a particular execution path for completion of a task/prediction, and/or have a particular execution path chosen for completion of such a task/prediction.

According to an embodiment, parties to a collaborative computing system (e.g., parties 102 in system 100) may comprise a “model owner” that owns or controls particular models (e.g., model 106) that may be used to process proprietary parameters and/or secrets to determine a computed task/prediction result (e.g., task/prediction result 108). Such a model owner may have knowledge of and/or visibility into various aspects of a collaborative computing system, and may train a model based, at least in part, on available proprietary parameters and/or secrets to perform a particular task and/or prediction. Such a model owner may state a performance, reliability and/or costs associated with use and/or execution of such a model. Such a model owner may also set publishing options (including extensibility), and/or identify any open source features of such a model. Such a model owner may also receive compensation and/or reward from task owners for use of such a model to obtain a computed task and/or prediction.

According to an embodiment, different sets of proprietary parameters and/or secrets (e.g., sets of proprietary parameter and/or secrets owned and/or controlled by different owners) may be combined in the course of completing a computing task/prediction. In an example illustration, a first owner of a first set of proprietary parameters and/or secrets (maintained according to a first schema) may sell tires to five automobile manufacturers and a task owner/customer (e.g., an automobile manufacturer) may desire a prediction of a failure of a braking system. In an embodiment, the first owner of the first set of proprietary parameters and/or secrets may be aware of the desire by the task owner to predict failure of the braking system and the task owner may be aware the first set of proprietary parameters and/or secrets possessed by the first owner. According to an embodiment, a machine learning process may determine that the first set of proprietary parameters and/or secrets may be useful in computing the desired prediction of a failure in the braking system. A second owner of a second set of proprietary parameters and/or secrets may advertise that the second set of proprietary parameters and/or secrets would be useful in computing the desired prediction, but that the second set of proprietary parameters and/or secrets is maintained according to a second schema (different from the first schema). Here, a machine learning process may transform the second set of proprietary parameters and/or secrets to be compatible with the first schema. According to an embodiment, the task owner may select an appropriate desired schema, and have the first set of proprietary parameters and/or secrets to be formatted according to the desired schema. A model generated based, at least in part, on the first set of proprietary parameters and/or values may be used to generate the desired prediction with a certain level of accuracy such as, for example, seventy percent accuracy. Here, the generated model may enable and/or generate compensation for multiple different parties including, for example, the first owner of a first set of proprietary parameters and/or secrets, a processing entity and/or a machine learning model provider. According to an embodiment, schema may be adjusted such that the second set of proprietary parameters and/or secrets may be incorporated to retrain the machine learning model to provide the desired prediction with an increased level of accuracy such as, for example, 80 percent accuracy.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long-haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standarcyps and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public. According to an embodiment, a signal packet and/or frame may comprise all or a portion of a “message” transmitted between devices. In an implementation, a message may comprise signals and/or states expressing content to be delivered to a recipient device. For example, a message may at least in part comprise a physical signal in a transmission medium that is modulated by content that is to be stored in a non-transitory storage medium at a recipient device, and subsequently processed.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, or 4G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

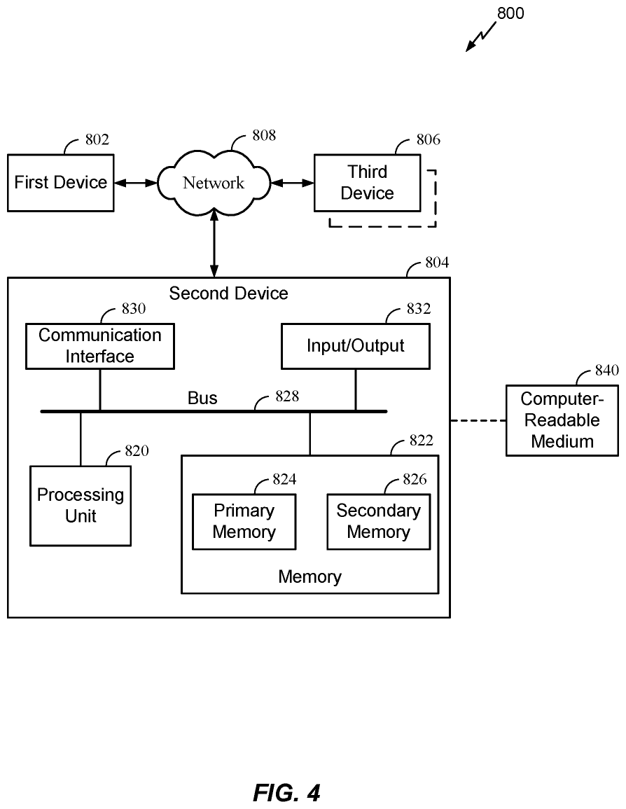

In one example embodiment, as shown in FIG. 4, a system embodiment may comprise a local network (e.g., device 804 and medium 840) and/or another type of network, such as a computing and/or communications network. For purposes of illustration, therefore, FIG. 4 shows an embodiment 800 of a system that may be employed to implement either type or both types of networks. Network 808 may comprise one or more network connections, links, processes, services, applications, and/or resources to facilitate and/or support communications, such as an exchange of communication signals, for example, between a computing device, such as 802, and another computing device, such as 806, which may, for example, comprise one or more client computing devices and/or one or more server computing device. By way of example, but not limitation, network 808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 4 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present patent application at least, this is understood to refer to sufficient structure within the meaning of 35 USC § 112 (f) so that it is specifically intended that 35 USC § 112 (f) not be implicated by use of the term “computing device” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1, 2 and 3 in the text associated with the foregoing figure(s) of the present patent application.

Referring now to FIG. 4, in an embodiment, first and third devices 802 and 806 may be capable of rendering a graphical user interface (GUI) for a network device and/or a computing device, for example, so that a user-operator may engage in system use. Device 804 may potentially serve a similar function in this illustration. Likewise, in FIG. 4, computing device 802 (‘first device’ in figure) may interface with computing device 804 (‘second device’ in figure), which may, for example, also comprise features of a client computing device and/or a server computing device, in an embodiment. Processor (e.g., processing device) 820 and memory 822, which may comprise primary memory 824 and secondary memory 826, may communicate by way of a communication bus 815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 804, as depicted in FIG. 4, is merely one example, and claimed subject matter is not limited in scope to this particular example. FIG. 4 may further comprise a communication interface 830 which may comprise circuitry and/or devices to facilitate transmission of messages between second device 804 and first device 802 and/or third device 806 in a physical transmission medium over network 808 using one or more network communication techniques identified herein, for example. In a particular implementation, communication interface 830 may comprise a transmitter device including devices and/or circuitry to modulate a physical signal in physical transmission medium according to a particular communication format based, at least in part, on a message that is intended for receipt by one or more recipient devices. Similarly, communication interface 830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 5D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 4, computing device 802 may provide one or more sources of executable computer instructions in the form physical states and/or signals (e.g., stored in memory states), for example. Computing device 802 may communicate with computing device 804 by way of a network connection, such as via network 808, for example. As previously mentioned, a connection, while physical, may not necessarily be tangible. Although computing device 804 of FIG. 4 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 822 may comprise any non-transitory storage mechanism. Memory 822 may comprise, for example, primary memory 824 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 822 may be utilized to store a program of executable computer instructions. For example, processor 820 may fetch executable instructions from memory and proceed to execute the fetched instructions. Memory 822 may also comprise a memory controller for accessing device readable-medium 840 that may carry and/or make accessible digital content, which may include code, and/or instructions, for example, executable by processor 820 and/or some other device, such as a controller, as one example, capable of executing computer instructions, for example. Under direction of processor 820, a non-transitory memory, such as memory cells storing physical states (e.g., memory states), comprising, for example, a program of executable computer instructions, may be executed by processor 820 and able to generate signals to be communicated via a network, for example, as previously described. Generated signals may also be stored in memory, also previously suggested.

Memory 822 may store electronic files and/or electronic documents, such as relating to one or more users, and may also comprise a computer-readable medium that may carry and/or make accessible content, including code and/or instructions, for example, executable by processor 820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 4, processor 820 may comprise one or more circuits, such as digital circuits, to perform at least a portion of a computing procedure and/or process. By way of example, but not limitation, processor 820 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 4 also illustrates device 804 as including a component 832 operable with input/output devices, for example, so that signals and/or states may be appropriately communicated between devices, such as device 804 and an input device and/or device 804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

Some embodiments disclosed herein are directed to an apparatus comprising: one or more memory devices; and one or more processors coupled to the one or memory devices to electronically determine a value of computing a result, the computing result to be determined based, at least in part on input values provided by multiple input value providing parties; and electronically determine a distribution of gains from computation of the result between and/or among multiple parties including at least input value providing parties. In a particular implementation, the one or more processors may be further to electronically sharing input values provided by the multiple input value providing entities at multiple levels of granularity to compute the result. In another particular implementation, the multiple parties may comprise the input value providing parties, one or more model providing parties or one or more processor providing parties, or a combination thereof. In another particular implementation, the one or more processors are further to electronically maintain input values provided by the multiple input value providing parties as signals and/or states in one or more physical devices expressing proprietary parameters and/or values in a common format. In another particular implementation, the one or more processors are further to electronically iterate a machine-learning model to complete a compute task and/or prediction result based, at least in part, on the input values. In another particular implementation, the one or more processors are further to electronically determine the value of computing the result by application of metrics including at least accuracy or reliability metrics. In another particular implementation, the one or more processors are further to determine the distribution of gains from computation of the result value based, at least in part, on a determination of a perceived contribution of proprietary parameters and/or values by individual ones of the multiple input value providing parties in determination of the computed result. In another particular implementation, the one or more processors are further to electronically transform the input values provided by the multiple input value providing parties for storage in a shared common storage. In one example, the one or more processors are further to electronically apply homomorphic encryption, federated learning, masking, query restriction or usage tracking, or a combination thereof, to input values provided by one or more of the multiple input value providing parties. In another particular example, input values provided by the one or more multiple input providing parties are provided at different input value granularities, and the one or more processors are further to electronically combine input values provided by the one or multiple input providing entities at different input value granularities by electronically reward to input providing parties that improve granularity of contributed proprietary parameters and/or values, or electronically compensate a model providing party to combine input values provided at different granularities. In another example, input values provided by the one or more multiple input providing parties are provided at different input value granularities, and the one or more processors are further to electronically enable sharing of proprietary parameters and/or secrets at a raw granularity, partially aggregated proprietary parameters and/or secrets or proprietary parameters and/or secrets generated by a sub-coalition of input providing parties, or a combination thereof. In another particular implementation, the one or more processors are further to electronically limit use of at least a portion of input values provided by at least one of the input value providing parties for computation of particular tasks. In another particular implementation, at least one of the multiple parties comprises a task owner that controls and/or owns a particular task and/or prediction to be computed based, at least in part, on the input values provide by the multiple input value providing parties, and wherein the task owner publishes one or more attributes of the particular task and/or prediction to include a goal, success criteria, a bounty, identification of functions/processes sought for computation of the particular task and/or prediction, a time scale for computation of the particular task and/or prediction, geography, reputation, identification of particular proprietary parameters and/or secret sought for use in computing the particular task and/or prediction, identification of particular models sought for use in computing the particular task and/or prediction or particular schema sought for use in computing the particular task and/or prediction, or a combination thereof. In another particular implementation, at least one of the multiple parties comprises a model owner that controls and/or owns a particular model that may be used for computation of the result based, at least in part, on the input values, and wherein the model owner publishes one or more performance expectations, one or more accuracy expectations, one or more reliability expectations, one or more cost expectations, one or more open source features or an expected reward, or a combination thereof, associated with use of the model for computation of the result.

Other embodiments disclosed herein are directed to an article comprising: a non-transitory storage medium comprising computer-readable instructions stored thereon which are executable by one or more processors of a computing device electronically determine a value of computing a result, the computing result to be determined based, at least in part on input values provided by multiple input value providing parties; and electronically determine a distribution of gains from computation of the result between and/or among multiple parties including at least input value providing parties. In a particular implementation, the computer-readable instructions may be further executable by the one or more processors of the computing device to electronically sharing input values provided by the multiple input value providing entities at multiple levels of granularity to compute the result. In another particular implementation, the multiple parties may comprise the input value providing parties, one or more model providing parties or one or more processor providing parties, or a combination thereof. In another particular implementation, the computer-readable instructions may be further executable by the one or more processors of the computing device to electronically maintain input values provided by the multiple input value providing parties as signals and/or states in one or more physical devices expressing proprietary parameters and/or values in a common format. In another particular implementation, the computer-readable instructions may be further executable by the one or more processors of the computing device to electronically iterate a machine-learning model to complete a compute task and/or prediction result based, at least in part, on the input values. In another particular implementation, the computer-readable instructions may be further executable by the one or more processors of the computing device to electronically determine the value of computing the result by application of metrics including at least accuracy or reliability metrics. In another particular implementation, the computer-readable instructions may be further executable by the one or more processors of the computing device to determine the distribution of gains from computation of the result value based, at least in part, on a determination of a perceived contribution of proprietary parameters and/or values by individual ones of the multiple input value providing parties in determination of the computed result. In another particular implementation, the computer-readable instructions may be further executable by the one or more processors of the computing device to electronically transform the input values provided by the multiple input value providing parties for storage in a shared common storage. In one example, the computer-readable instructions may be further executable by the one or more processors of the computing to electronically apply homomorphic encryption, federated learning, masking, query restriction or usage tracking, or a combination thereof, to input values provided by one or more of the multiple input value providing parties. In another particular example, input values provided by the one or more multiple input providing parties are provided at different input value granularities, and the computer-readable instructions may be further executable by the one or more processors of the computing device to electronically combine input values provided by the one or multiple input providing entities at different input value granularities by electronically reward to input providing parties that improve granularity of contributed proprietary parameters and/or values, or electronically compensate a model providing party to combine input values provided at different granularities. In another example, input values provided by the one or more multiple input providing parties are provided at different input value granularities, and the computer-readable instructions may be further executable by the one or more processors of the computing device to electronically enable sharing of proprietary parameters and/or secrets at a raw granularity, partially aggregated proprietary parameters and/or secrets or proprietary parameters and/or secrets generated by a sub-coalition of input providing parties, or a combination thereof. In another particular implementation, the computer-readable instructions may be further executable by the one or more processors of the computing device to electronically limit use of at least a portion of input values provided by at least one of the input value providing parties for computation of particular tasks. In another particular implementation, at least one of the multiple parties comprises a task owner that controls and/or owns a particular task and/or prediction to be computed based, at least in part, on the input values provide by the multiple input value providing parties, and wherein the task owner publishes one or more attributes of the particular task and/or prediction to include a goal, success criteria, a bounty, identification of functions/processes sought for computation of the particular task and/or prediction, a time scale for computation of the particular task and/or prediction, geography, reputation, identification of particular proprietary parameters and/or secret sought for use in computing the particular task and/or prediction, identification of particular models sought for use in computing the particular task and/or prediction or particular schema sought for use in computing the particular task and/or prediction, or a combination thereof. In another particular implementation, at least one of the multiple parties comprises a model owner that controls and/or owns a particular model that may be used for computation of the result based, at least in part, on the input values, and wherein the model owner publishes one or more performance expectations, one or more accuracy expectations, one or more reliability expectations, one or more cost expectations, one or more open source features or an expected reward, or a combination thereof, associated with use of the model for computation of the result.

Other embodiments described herein are directed to an apparatus comprising: means for electronically determining a value of computing a result, the computing result to be determined based, at least in part on input values provided by multiple input value providing parties; and means for electronically determining a distribution of gains from computation of the result between and/or among multiple parties including at least input value providing parties. In a particular implementation, the apparatus may further comprise means for electronically sharing input values provided by the multiple input value providing entities at multiple levels of granularity to compute the result. In another particular implementation, the multiple parties comprise the input value providing parties, one or more model providing parties or one or more processor providing parties, or a combination thereof. In another particular implementation, the apparatus may further comprise means for electronically maintaining input values provided by the multiple input value providing parties as signals and/or states in one or more physical devices expressing proprietary parameters and/or values in a common format. In another particular implementation, the apparatus may further comprise means for electronically iterating a machine-learning model to complete a compute task and/or prediction result based, at least in part, on the input values. In another particular implementation, the means for electronically determining the value of computing the result further comprises means for electronically applying metrics including at least accuracy or reliability metrics. In another particular implementation, the apparatus may further comprise means for electronically determining the distribution of gains from computation of the result value based, at least in part, on a determination of a perceived contribution of proprietary parameters and/or values by individual ones of the multiple input value providing parties in determination of the computed result. In another particular implementation, the apparatus may further comprise means for electronically transforming the input values provided by the multiple input value providing parties for storage in a shared common storage. In one example, the apparatus may further comprise means for electronically applying homomorphic encryption, federated learning, masking, query restriction or usage tracking, or a combination thereof, to input values provided by one or more of the multiple input value providing parties. In another example, input values provided by the one or more multiple input providing parties are provided at different input value granularities, and the apparatus further comprises means for electronically combining input values provided by the one or multiple input providing entities at different input value granularities by electronically rewarding input providing parties that improve granularity of contributed proprietary parameters and/or values, or means for electronically compensating a model providing party to combine input values provided at different granularities. In yet another example, input values provided by the one or more multiple input providing parties are provided at different input value granularities, and the apparatus further comprises means for electronically enabling sharing of proprietary parameters and/or secrets at a raw granularity, partially aggregated proprietary parameters and/or secrets or proprietary parameters and/or secrets generated by a sub-coalition of input providing parties, or a combination thereof. In another particular implementation, the apparatus may further comprise means for electronically limiting use of at least a portion of input values provided by at least one of the input value providing parties for computation of particular tasks. In another particular implementation, at least one of the multiple parties comprises a task owner that controls and/or owns a particular task and/or prediction to be computed based, at least in part, on the input values provide by the multiple input value providing parties, and wherein the task owner publishes one or more attributes of the particular task and/or prediction to include a goal, success criteria, a bounty, identification of functions/processes sought for computation of the particular task and/or prediction, a time scale for computation of the particular task and/or prediction, geography, reputation, identification of particular proprietary parameters and/or secret sought for use in computing the particular task and/or prediction, identification of particular models sought for use in computing the particular task and/or prediction or particular schema sought for use in computing the particular task and/or prediction, or a combination thereof. In another particular implementation, at least one of the multiple parties comprises a model owner that controls and/or owns a particular model that may be used for computation of the result based, at least in part, on the input values, and wherein the model owner publishes one or more performance expectations, one or more accuracy expectations, one or more reliability expectations, one or more cost expectations, one or more open source features or an expected reward, or a combination thereof, associated with use of the model for computation of the result.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
electronically determining a value of computing a result, the computing result to be determined based, at least in part on input values provided by multiple input value providing parties; and
electronically determining a distribution of gains from computation of the result between and/or among multiple parties including at least input value providing parties.

2. The method of claim 1, and further comprising electronically sharing input values provided by the multiple input value providing entities at multiple levels of granularity to compute the result.

3. The method of claim 1, wherein the multiple parties comprise the input value providing parties, one or more model providing parties or one or more processor providing parties, or a combination thereof.

4. The method of claim 1, and further comprising electronically maintaining input values provided by the multiple input value providing parties as signals and/or states in one or more physical devices expressing proprietary parameters and/or values in a common format.

5. The method of claim 1, and further comprising electronically iterating a machine-learning model to complete a compute task and/or prediction result based, at least in part, on the input values.

6. The method of claim 1, wherein electronically determining the value of computing the result further comprises applying metrics including at least accuracy or reliability metrics.

7. The method of claim 1, and further comprising electronically determining the distribution of gains from computation of the result value based, at least in part, on a determination of a perceived contribution of proprietary parameters and/or values by individual ones of the multiple input value providing parties in determination of the computed result.

8. The method of claim 1, and further comprising electronically transforming the input values provided by the multiple input value providing parties for storage in a shared common storage.

9. The method of claim 8, and further comprising electronically applying homomorphic encryption, federated learning, masking, query restriction or usage tracking, or a combination thereof, to input values provided by one or more of the multiple input value providing parties.

10. The method of claim 8, wherein input values provided by the one or more multiple input providing parties are provided at different input value granularities, and further comprising electronically combining input values provided by the one or multiple input providing entities at different input value granularities by electronically rewarding input providing parties that improve granularity of contributed proprietary parameters and/or values, or electronically compensating a model providing party to combine input values provided at different granularities.

11. The method of claim 8, wherein input values provided by the one or more multiple input providing parties are provided at different input value granularities, and further comprising electronically enabling sharing of proprietary parameters and/or secrets at a raw granularity, partially aggregated proprietary parameters and/or secrets or proprietary parameters and/or secrets generated by a sub-coalition of input providing parties, or a combination thereof.

12. The method of claim 1, and further comprising electronically limiting use of at least a portion of input values provided by at least one of the input value providing parties for computation of particular tasks.

13. The method of claim 1, and wherein at least one of the multiple parties comprises a task owner that controls and/or owns a particular task and/or prediction to be computed based, at least in part, on the input values provide by the multiple input value providing parties, and wherein the task owner publishes one or more attributes of the particular task and/or prediction to include a goal, success criteria, a bounty, identification of functions/processes sought for computation of the particular task and/or prediction, a time scale for computation of the particular task and/or prediction, geography, reputation, identification of particular proprietary parameters and/or secret sought for use in computing the particular task and/or prediction, identification of particular models sought for use in computing the particular task and/or prediction or particular schema sought for use in computing the particular task and/or prediction, or a combination thereof.

14. The method of claim 1, and wherein at least one of the multiple parties comprises a model owner that controls and/or owns a particular model that may be used for computation of the result based, at least in part, on the input values, and wherein the model owner publishes one or more performance expectations, one or more accuracy expectations, one or more reliability expectations, one or more cost expectations, one or more open source features or an expected reward, or a combination thereof, associated with use of the model for computation of the result.

15. An apparatus comprising:
one or more memory devices; and
one or more processors coupled to the one or memory devices to electronically determine a value of computing a result, the computing result to be determined based, at least in part on input values provided by multiple input value providing parties; and
electronically determine a distribution of gains from computation of the result between and/or among multiple parties including at least input value providing parties.

16. The apparatus of claim 15, wherein the one or more processors are further to comprising electronically share input values provided by the multiple input value providing entities at multiple levels of granularity to compute the result.

17. The apparatus of claim 15, wherein the multiple parties comprise the input value providing parties, one or more model providing parties or one or more processor providing parties, or a combination thereof.

18. An article comprising:
a non-transitory storage medium comprising computer-readable instructions stored thereon which are executable by one or more processors of a computing device to:
electronically determine a value of computing a result, the computing result to be determined based, at least in part on input values provided by multiple input value providing parties; and
electronically determine a distribution of gains from computation of the result between and/or among multiple parties including at least input value providing parties.

19. The article of claim 18, wherein the computer-readable instructions are further executable by the one or more processors of the computing device to electronically determine the distribution of gains from computation of the result value based, at least in part, on a determination of a perceived contribution of proprietary parameters and/or values by individual ones of the multiple input value providing parties in determination of the computed result.

20. The article of claim 18, wherein the computer-readable instructions are further executable by the one or more processors of the computing device to electronically transform the input values provided by the multiple input value providing parties for storage in a shared common storage.
